(19) United States
(12) Patent Application Publication
(10) Pub. No.: US 2011/0258135 A1
(43) Pub. Date: Oct. 20, 2011

(54) Method for Planning the Travel Route of A Transport Vehicle, Transport Vehicle

(75) Inventors: Boris Paul, Bonn (DE); Keith Ulrich, Bonn-Oberkassel (DE)

(73) Assignee: Deutsche Post AG, Bonn (DE)

(21) Appl. No.: 13/141,967

(22) PCT Filed: Dec. 10, 2009
(86) PCT No.: PCT/EP09/66823

§ 371 Date: Jun. 23, 2011

(30) Foreign Application Priority Data
Dec. 30, 2008 (DE) 102008063377.1

(51) Int. Cl. G06Q 10/00; G01C 21/34

(52) U.S. Cl. 705/338

(57) ABSTRACT

There is provided a method for planning the travel route of a transport vehicle by which a plurality of transported items are transported. The method comprises providing an RFID tag for each transported item, wherein RFID antennas on the transport vehicle determine the load of the transport vehicle in that the individual RFID tags of the transported items are scanned inside the transport vehicle. The method also comprises scanning the RFID tags belonging to the transported items before the transport vehicle is loaded, via a reading process on an RFID packing bench. The route is planned at least on a basis of destination addresses for the transported items. The route may be changed dynamically on the basis of current traffic conditions and on the basis of items that have been newly loaded into the transport vehicle.

### CROSS-REFERENCE TO RELATED APPLICATIONS

Pursuant to 35 U.S.C. §371, this application is the United States National Stage Application of International Patent Application No. PCT/EP2009/066823, filed on Dec. 10, 2009, the contents of which are incorporated by reference as if set forth in their entirety herein, which claims priority to German (DE) Patent Application No. 10 2008 063 337.1, filed Dec. 30, 2008, the contents of which are incorporated by reference as if set forth in their entirety herein.

### BACKGROUND

In the realm of the delivery of shipments by logistics companies, many shipments are transported every day from senders to recipients via distribution centers. In this process, transport vehicles are used whose travel routes are specified daily on the basis of the shipments that have to be delivered. However, this route planning comprises the determination of the shortest or fastest route for delivering the shipment having certain destination addresses, whereby static information is processed for the route planning. The route thus calculated is displayed to the driver of the transport vehicle, preferably via a type of navigation system, so that he can deliver shipments in the prescribed sequence, a process in which the way along the calculated route is displayed to him.

Dynamic information such as the traffic status, construction sites or unfavorable weather conditions such as icy roads, however, are not taken into account during the route planning Instead, the route for a given day is specified on the basis of the shipments on hand in the morning and then it can no longer be changed. Whether the driver of the transport vehicle adheres to the prescribed route or, due to current conditions, chooses another route, cannot be indicated if the vehicle is not being tracked, for example, by means of a GPS system. The experience of the driver about how to plan the route so that it is faster cannot be taken into account either, which is detrimental to the general route optimization.

If the driver on his route is, for instance, requested to make an ad hoc pick-up of an express shipment from a sender, this likewise cannot be taken into account by changing the route or by first ascertaining which transport vehicle is suitable for the pick-up. Here, it should be pointed out that it is normally not known which shipments a driver has loaded at a certain point in time, which ones have already been delivered and which ones have been added. The current load status of vehicles and their capacity utilization are likewise not known.

However, in order to overcome these deficiencies of conventional route planning approaches, there is a need to provide systems that allow a high level of dynamic route planning

### SUMMARY

The subject innovation relates to a method for planning the travel route of a transport vehicle by which a plurality of transported items are transported, whereby the route planning takes place at least on the basis of the destination addresses for the transported items, and each transported item is provided with an RFID transponder. The subject innovation may relate to a method and an appertaining transport vehicle with which such a high level of dynamic route planning can be achieved.

An exemplary embodiment comprises a method for planning the travel route of a transport vehicle with which a plurality of transported items are transported, whereby the route planning takes place at least on the basis of the destination addresses for the transported items, and each transported item is provided with an RFID transponder. In this context, RFID antennas on the transport vehicle determine the load of the transport vehicle in that the individual RFID transponders of the transported items are scanned inside the transport vehicle. The route planning is changed dynamically on the basis of current traffic conditions and on the basis of items that have been newly loaded into the transport vehicle.

Preferably, the dynamic route planning is carried out in a central data management unit and, in each case, an updated route is transmitted from the central data management unit to a navigation system on the transport vehicle.

An exemplary embodiment comprises at least one transport vehicle for carrying out method, whereby the interior of the transport vehicle is equipped with several RFID antennas that are configured in such a way that RFID transponders can be scanned anywhere in the interior.

Advantages, special features and advantageous refinements of the subject innovation can be gleaned from the presentation below of exemplary embodiments.

### BRIEF DESCRIPTION OF THE DRAWINGS

The above-mentioned and additional advantages, special features and advantageous refinements of the subject innovation are also illustrated on the basis of the embodiments that are described below with reference to the figures.

FIG. 1 is a block diagram of a dynamic route planning system;

FIG. 2 is block diagram of an RFID technology system;

FIG. 3 is a block diagram of an antenna system;

FIG. 4 is a block diagram of an antenna system;

FIG. 5 is a block diagram of a system including a vehicle device; and

FIG. 6 is a block diagram of a communication system.

### DESCRIPTION OF SPECIFIC EMBODIMENTS

The-subject innovation may combine two aspects in an advantageous manner. First of all, there is dynamic route planning that can be performed daily on the basis of the transport items actually intended for a given transport vehicle. This can comprise multi-stop routing on the basis of streets or even house numbers. The dynamic route planning can take into account current traffic conditions such as traffic jams, or else weather conditions such as icy roads. The current traffic conditions can be obtained from service providers or from other transport vehicles of a fleet of vehicles. Here, especially fleets of vehicles of the police, taxis or transport vehicles of the logistics company itself can be used.

The dynamic route planning is displayed to the driver of a vehicle, preferably via a navigation system.

The use of RFID technology makes it possible to have access to the load status of a transport vehicle at any point in time for purposes of planning the route. Every loading and unloading procedure can be registered. In particular, the current capacity of a given vehicle can be determined so that ad hoc pick-ups can be scheduled while the vehicle is en route.

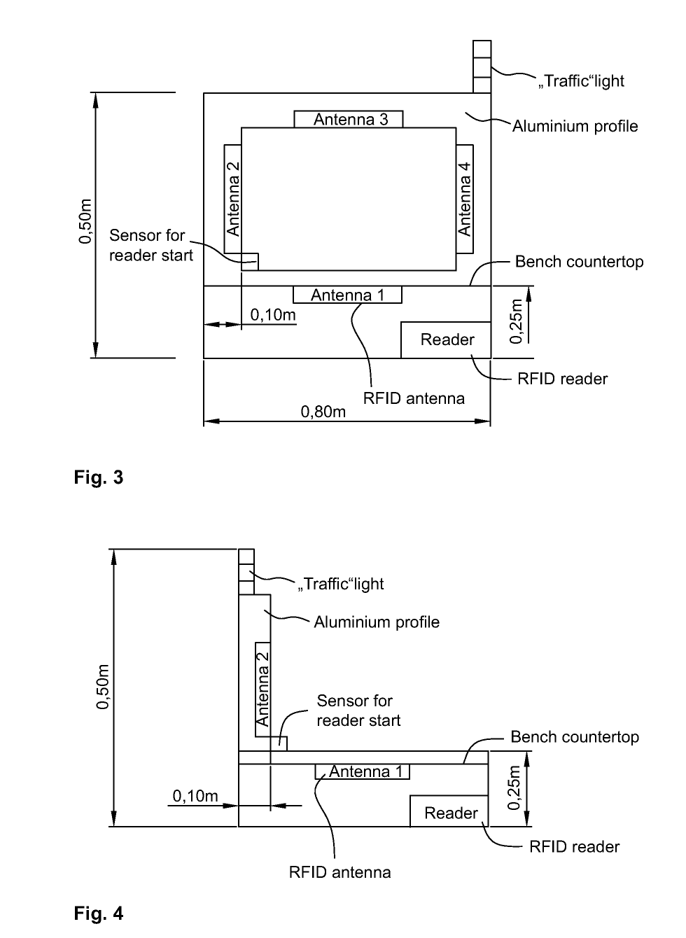

Before shipments are loaded into a transport vehicle, the appertaining RFID labels have to be recorded. A special RFID packing bench can be used in order to scan the box labels and, if applicable, article labels contained in them, during productive operation in real time. Two variants of this bench are shown schematically in FIGS. 3 and 4. The system consists of the following components:
aluminum frame profile,
RFID reader, antennas, sensors (e.g. light barriers), “traffic” lights,
IPC for control and display.

Here, it is provided as a process that a shipment labeled with an RFID tag is pushed through the RFID gate. The reading process is triggered by means of a sensor (e.g. light barrier), and this is indicated by an orange light. After the recording has been successfully carried out, this is indicated by a green light, and the reading result is additionally displayed on a terminal. If no label is detected during the reading process, this is indicated by a red light.

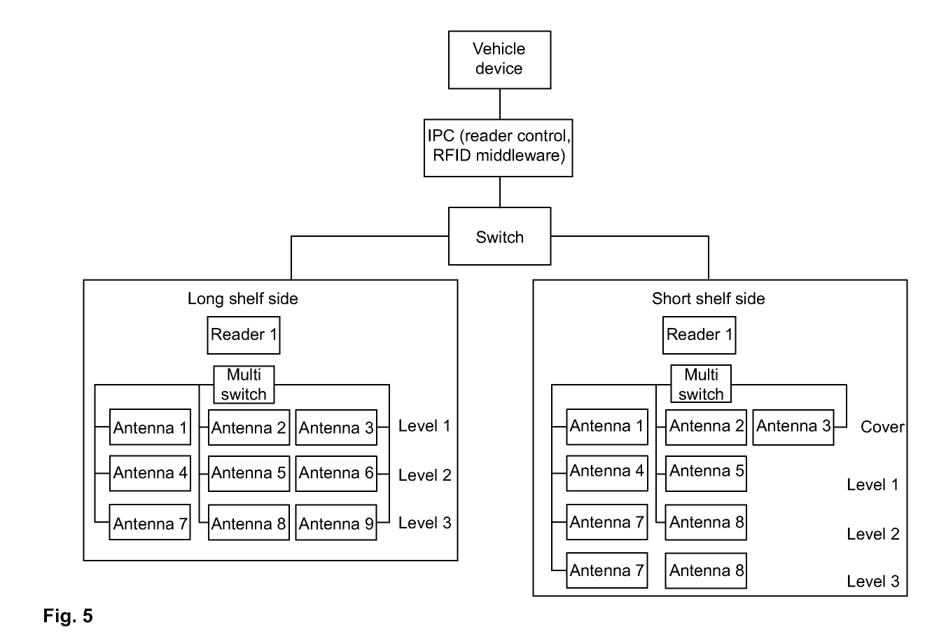

In order to scan shipments within a transport vehicle, appropriate RFID vehicle equipment is used during productive operations. This vehicle equipment is shown schematically in FIG. 5. This RFID solution allows a real-time scanning of the current load status of the vehicle by means of a special RFID solution and makes it possible to inform the driver or the central dispatching office of possible discrepancies. The system consists of the following components:
RFID equipment (readers and antennas) for the two shelf units in the vehicle,
“traffic” lights and, if applicable, a monitor for a visual display,
IPC for data processing,
RFID edgeware for the reader control.

Here, it is provided as a process that an initial loading of the vehicle and thus a scanning of all of the RFID tags of the loaded shipments is carried out, which is then followed by the transport. Then a shipment is delivered, as a result of which the load status changes. When a shipment is picked up from a sender, the load status also changes, and this is registered by the antennas.

The individual process steps are explained in bulleted form below.

Initial Loading:
IPC receives the loading list (target list) from the vehicle terminal.
The loading list contains the unambiguous shipment ID (shipment identifier) that is also stored on the RFID tag.
The driver loads the vehicle step-by-step.
During the loading, the RFID infrastructure system in the vehicle constantly ascertains the load status.
The load status is regularly transmitted to the vehicle device.
The step-by-step loading can be visually displayed by means of a “traffic” light and with a monitor.

Transport:
During the transport, the RFID infrastructure system in the vehicle constantly ascertains the load status.
The load status is regularly transmitted to the vehicle device.

Delivery:
The vehicle device sends a new target list (no longer contains the shipments that are to be unloaded) to the IPC.

The driver removes the shipments that are to be unloaded.

During the delivery, the RFID infrastructure system in the vehicle constantly ascertains the load status.
The load status is regularly transmitted to the vehicle device.
The delivery can be visually displayed by means of a “traffic” light and with a monitor.
After all of the shipments have been delivered, a deliverer does not have to fill in any forms or drop them off at a depot, etc. since all of the procedures have already been registered.

Pick-Up:
The driver picks up a new shipment from the sender.
The driver tags the shipment with a prepared RFID tag (programmed with a number that is to be defined and that is printed in plain text and as a barcode onto the tag).
The driver scans or manually enters the tag number into his hand-held device and links the tag to the Airway Bill Number (AWB number).
The vehicle device sends a new target list (containing the picked-up shipment) to the IPC.
The driver loads the new shipment into the vehicle.
During the loading, the RFID infrastructure system in the vehicle constantly ascertains the load status.
The load status is regularly transmitted to the vehicle device.
The loading can be visually displayed by means of a “traffic” light and with a monitor.

The transport vehicle is preferably in constant communication with a central data management unit in which the data of all of the transport vehicles is processed. This connection can be established, for example, by means of GSM. Moreover, the position of a vehicle can be determined by means of satellite positioning.

The dynamic route planning according to the invention is supposed to take the current road status into account and to keep transport vehicles away from roads with heavy traffic. Particularly in urban areas, the current road status is, however, hardly or not at all known. There are traffic monitoring systems for highways from which the status can be continuously requested. However, this does not exist for inner city streets or for local roads. Therefore, dynamic route planning with current traffic information is increasingly becoming the main factor for efficient and environmentally friendly logistics systems, especially in urban areas.

Many factors have to be taken into account in dynamic route planning. These include, for example, time frames for pick-ups and deliveries, free capacities in transport vehicles, information about traffic jams, construction sites, legal regulations such as toll roads or, for example, downtown access control. Moreover, it has to be taken into account whether vehicles are suitable for certain deliveries such as, for example, pharmaceuticals or food products. Furthermore, weather conditions can be taken into account.

Modern fleets of vehicles, e.g. belonging to the police, DHL or busses and taxis, are able to acquire the current traffic conditions in their vicinity, to record it and to make it available for dynamic route planning. This information can be transmitted to the central data management unit or directly to other vehicles. This is where so-called meshed networks can be used.

If a central data management unit is used, then vehicle information such as speed, acceleration, load and weight are also transmitted to this central data management unit.

The transport vehicle according to the invention entailing a complete RFID coverage area of the vehicle interior departs from with solutions in which a vehicle drives through an RFID gate so that all of the RFID tags located in it can be read, since this is associated with a fairly high rate of reading errors. In contrast, the targeted installation of RFID reading devices on all of the shelves of a vehicle allows a reliable scanning of every RFID tag located in the interior of the vehicle.

In one exemplary embodiment, RFID technology, in combination with a determination of the position of a transport vehicle (e.g. GPS coordinates), is also used to monitor the delivery of shipments to a destination address. For example, a shipment can only be taken out of the vehicle (and then delivered) if the vehicle is within a certain range of a given destination address. Otherwise, an alarm or a notification is sent to the central data management unit. Here, however, it can also be provided that the route planning allows several shipments that are intended for addresses in a certain area to be taken out of the vehicle at the same time, without this triggering an alarm. If the destination addresses of several shipments are, for example, in one street, it can be calculated for the route planning that it is more time-efficient for the vehicle to schedule only one stop at which the deliverer delivers several shipments on foot.

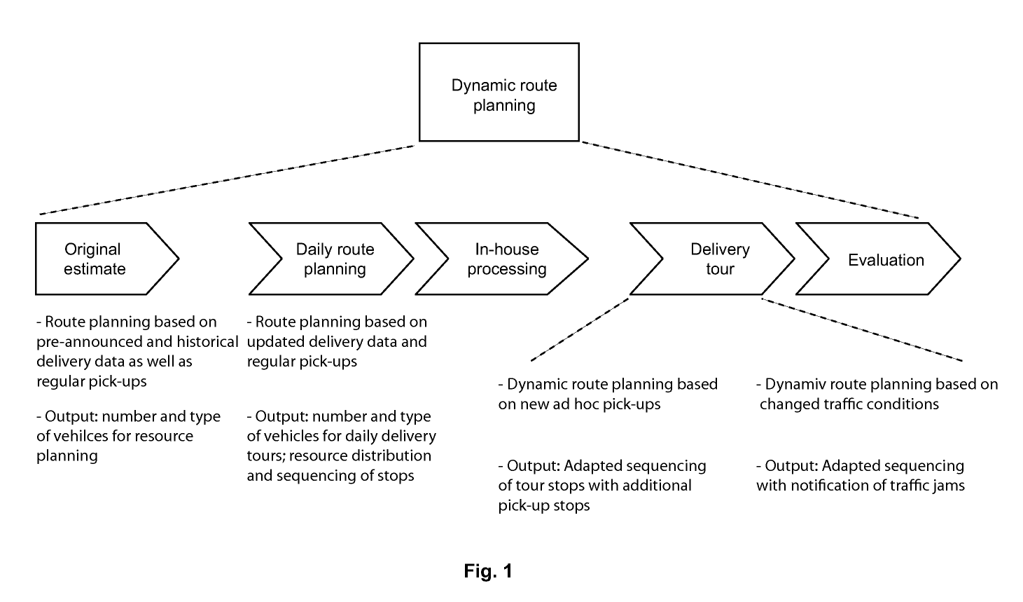

FIG. 1
Dynamic Route Planning
Original estimate
Daily route planning
In-house processing
Delivery tour
Evaluation
   Route planning based on pre-announced and historical delivery data as well as regular pick-ups
   Output: number and type of vehicles for resource planning
   Route planning based on updated delivery data and regular pick-ups
   Output: number and type of vehicles for daily delivery tours; resource distribution and sequencing of stops
   Dynamic route planning based on new ad hoc pick-ups
   Output: adapted sequencing of tour stops with additional pick-up stops
   Dynamic route planning based on changed traffic conditions
   Output: adapted sequencing with notification of traffic jams

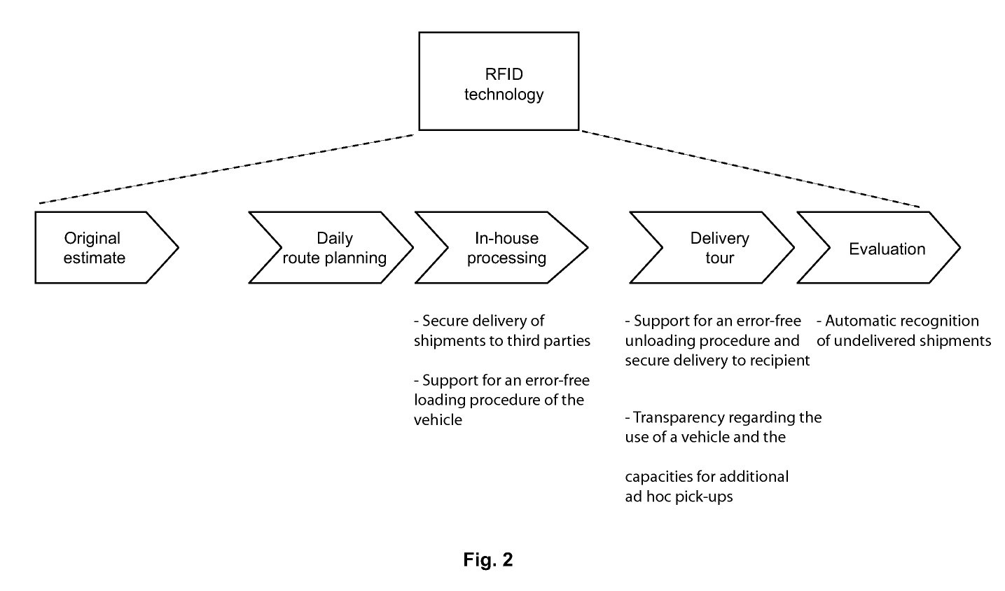

FIG. 2
RFID technology
Original estimate
Daily route planning
In-house processing
Delivery tour
Evaluation
   Secure delivery of shipments to third parties
   Support for an error-free loading procedure of the vehicle
   Support for an error-free unloading procedure and secure delivery to recipient
   Transparency regarding the use of a vehicle and the capacities for additional ad hoc pick-ups
   Automatic recognition of undelivered shipments

FIG. 3
Sensor for Reader Start
Antenna 1
Antenna 2
Antenna 3
Antenna 4
“Traffic” light
Aluminum profile
Bench countertop
Reader
RFID antenna
RFID reader

FIG. 4
“Traffic” light
Aluminum profile
Sensor for reader start
Antenna 2
Bench countertop
Antenna 1
Reader
RFID antenna
RFID reader

FIG. 5
Vehicle device
IPC
(reader control, RFID middleware)
Switch
Long shelf side
Reader 1
Multi-switch

| | | | |
|---|---|---|---|
| Antenna 1 | Antenna 2 | Antenna 3 | Level 1 |
| Antenna 4 | Antenna 5 | Antenna 6 | Level 2 |
| Antenna 7 | Antenna 8 | Antenna 9 | Level 3 |

Short shelf side
Reader 1
Multi-switch

| | | | |
|---|---|---|---|
| Antenna 1 | Antenna 2 | Antenna 3 | Cover |
| Antenna 4 | Antenna 5 | | Level 1 |
| Antenna 7 | Antenna 8 | | Level 2 |
| Antenna 7 | Antenna 8 | | Level 3 |

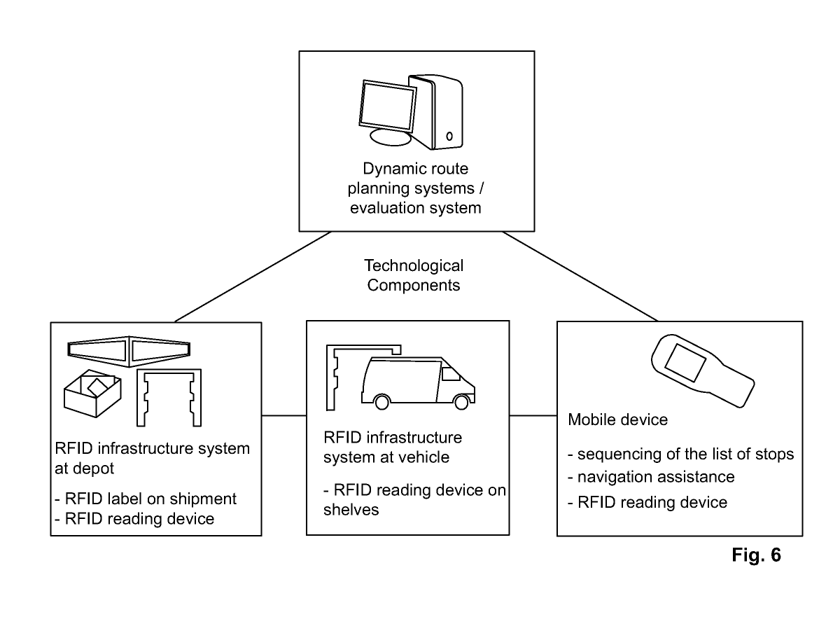

FIG. 6
Dynamic route
planning systems/evaluation system
Technological
Components
RFID infrastructure system at depot
   RFID label on shipment
   RFID reading device
RFID infrastructure system in vehicle
   RFID reading device on shelves
Mobile device
   sequencing of the list of stops
   navigation assistance
   RFID reading device

1-3. (canceled)

4. A method for planning the travel route of a transport vehicle by which a plurality of transported items are transported, the method comprising:
providing an RFID tag for each transported item, wherein RFID antennas on the transport vehicle determine the load of the transport vehicle in that the individual RFID tags of the transported items are scanned inside the transport vehicle;
scanning the RFID tags belonging to the transported items before the transport vehicle is loaded, via a reading process on an RFID packing bench;
planning the route at least on a basis of a destination addresses for the transported items; and
changing the route planning dynamically on the basis of current traffic conditions and on the basis of items that have been newly loaded into the transport vehicle.

5. The method recited in claim 4, comprising pushing a transported item that has been provided with an RFID tag through an RFID gate of the packing bench.

6. The method recited in claim 5, comprising triggering the reading process with a light barrier.

7. The method recited in claim 6, comprising indicating the positive scanning of the RFID tag by a green light.

8. The method recited in claim 6, displaying the reading result on a terminal.

9. The method recited in claim 6, comprising indicating that no label was detected during the reading process with a red light.

10. The method recited in claim 4, comprising:
carrying out the dynamic route planning in a central data management unit; and
transmitting, in each case, an updated route from the central data management unit to a navigation system on the transport vehicle.

11. An RFID packing bench that performs a reading process by scanning RFID tags belonging to transported items before a transport vehicle is loaded with the transported items, the RFID packing bench being used as part of a process of planning the travel route of the transport vehicle by which the transported items are transported, each transported item being provided with an RFID tag, wherein RFID antennas on the transport vehicle determine the load of the transport vehicle in that the individual RFID tags of the transported items are scanned inside the transport vehicle, the route being planned at least on a basis of a destination addresses for the transported items, and the route planning being changed dynamically on the basis of current traffic conditions and on the basis of items that have been newly loaded into the transport vehicle, the RFID packing bench comprising:
an RFID reader and several antennas arranged on the packing bench for scanning the RFID labels of the transported items.

12. The RFID packing bench recited in claim 11, comprising an RFID gate for reading the transported items that have been labeled with an RFID tag.

13. The RFID packing bench recited in claim 11, comprising a sensor for triggering the reading process for the RFID tags.

14. The packing bench recited in claim 11, comprising a “traffic” light for displaying a reading result of the reading process.

15. The packing bench recited in claim 11, comprising an IPC for controlling the packing bench and a terminal for displaying the reading result.

16. The packing bench recited in claim 11, comprising a countertop, wherein the RFID reader is arranged below the countertop.

17. The packing bench recited in claim 11, comprising a countertop, wherein at least one of the antennas is arranged above the countertop and at least one of the antennas is arranged below the countertop.

18. A system for transporting items, comprising:
a transport vehicle that receives a plurality of transported items, each of the plurality of transported items having an RFID tag, the transport vehicle comprising a plurality of antennas disposed therein to determine a load of the transport vehicle in that the individual RFID tags of the transported items are scanned inside the transport vehicle, the plurality of antennas being configured in such a way that RFID tags can be scanned anywhere in the interior;
an RFID packing bench that employs a reading process to scan the RFID tags belonging to the transported items before the transport vehicle is loaded;
wherein a route of the transport vehicle is planned at least on a basis of a destination addresses for the transported items; and
wherein the route planning dynamically changes on the basis of current traffic conditions and on the basis of items that have been newly loaded into the transport vehicle.
